(19) United States
(12) Patent Application Publication
(10) Pub. No.: US 2015/0295919 A1
(43) Pub. Date: Oct. 15, 2015

(54) SELF-AUTHENTICATING CARD

(71) Applicant: DE SONNEVILLE INTERNATIONAL LTD., George Town (KY)

(72) Inventors: Dennis Bernard Van Kerrebroeck, Toronto (CA); Craig Michael Horn, London (GB)

(73) Assignee: DE SONNEVILLE INTERNATIONAL LTD., George Town (KY)

(21) Appl. No.: 14/249,202

(22) Filed: Apr. 9, 2014

(51) Int. Cl. H04L 29/06; H04W 4/00; G06K 19/06

(52) U.S. Cl. CPC H04L 63/0853; G06K 19/06187; H04W 4/008

(57) ABSTRACT

A self-authenticating card includes a magnetic stripe storing a card authentication code and a network authentication code. The card also includes an authentication circuit that is operable to read the card authentication code and the network authentication code from the magnetic stripe using at least one sensor and authenticate the card using the card authentication code by comparing the card authentication code with an expected code stored in memory separate from the magnetic stripe. In response to authenticating the card using the card authentication code, the authentication circuit enables data communication with a card reader, provides the network authentication code to the card reader, generates a new network authentication code, and writes the new network authentication code to the magnetic stripe using at least one write head.

### TECHNICAL FIELD

This relates to user-borne cards such as payment cards and identity cards, and more particularly, to such cards capable of performing self-authentication to protect against counterfeiting.

### BACKGROUND

Each year, billions of dollars are lost worldwide to payment card fraud. Commonly, card information (e.g., credit/debit card account number, expiry date, etc.) is copied by fraudsters to create counterfeit cards that are used to conduct fraudulent transactions. For example, card information stored on a card's magnetic stripe may be copied when an unwitting user swipes the card in a compromised merchant point-of-sale (POS) terminal. Further, the proliferation of Internet use and e-commerce has created new opportunity for card information to fall into unscrupulous hands.

Some technological advances have been made in recent years to combat counterfeiting. For example, card issuers have introduced so-called “smart cards” that rely on embedded integrated circuit chips (“smart chips”) to provide certain security features. For example, smart cards may be configured to require user authentication (e.g., by entry of a secret numerical code) at the time of each transaction. Further, smart cards may be configured to communicate card information to merchant POS terminals in encrypted form to prevent that information from being copied.

However, these security features require merchants to replace their legacy POS terminals that read from a card's magnetic stripe with new terminals capable of communicating with a smart card's embedded chip. Such new terminals are costly and their adoption by merchants has not been uniform. Consequently, most smart cards also include a magnetic stripe to maintain compatibility with legacy magnetic-stripe merchant POS terminals. Of course, the downside is that information stored in that magnetic stripe can still be copied from such smart cards in conventional ways. Further, sophisticated fraudsters have discovered ways to replicate smart cards while circumventing the requirement for user authentication.

Serious problems are also caused by counterfeiting of other types of user-borne cards, such as, e.g., identity cards, driver's license cards, health care cards, military personnel card, etc. Counterfeit identity cards may be used to effect identity theft, to falsify age, to gain unauthorized entry (e.g., at security checkpoints, borders, etc.), and to obtain fraudulent access to public services or funds (e.g., health care services, social insurance benefits), by way of example.

Accordingly, there remains a need for improved cards and methods of using cards to protect against counterfeiting.

### SUMMARY

According to an aspect, there is provided a self-authenticating card. The card includes a magnetic stripe storing a card authentication code and a network authentication code; at least one sensor for reading from the magnetic stripe; at least one write-head for writing to the magnetic stripe; a communication interface for communicating with a card reader; and an authentication circuit interconnected to the at least one sensor, the at least one write head, and the communication interface. The authentication circuit is operable to read the card authentication code and the network authentication code from the magnetic stripe using the at least one sensor; and authenticate the card using the card authentication code by comparing the card authentication code to an expected code stored in memory separate from the magnetic stripe. The authentication circuit is also operable to, in response to authenticating the card using the card authentication code: enable data communication with the card reader by way of the communication interface; provide the network authentication code to the card reader by way of the communication interface; generate a new network authentication code; and write the new network authentication code to the magnetic stripe using the at least one write-head.

According to another aspect, there is provided a method of operating a card to authenticate itself, the card having a magnetic stripe and an authentication circuit in communication with the magnetic stripe. The method includes storing a card authentication code and a network authentication code on the magnetic stripe. The method also includes, at the authentication circuit, reading the card authentication code and the network authentication code from the magnetic stripe; and authenticating the card using the card authentication code by comparing the card authentication code with an expected code stored in memory separate from the magnetic stripe. The method also includes, in response to authenticating the card using the card authentication code: enabling data communication with a card reader; providing the network authentication code to the card reader; generating a new network authentication code; and writing the new network authentication code to the magnetic stripe.

According to a further aspect, there is provided a card authentication system including a card as described herein, wherein the card has a communication interface comprising a radio-frequency transmitter. The card authentication system also includes a computing device comprising: a radio-frequency receiver; a network communication interface; at least one processor, and memory interconnected to the at least one processor. The memory stores software code that, upon execution by the at least one processor, causes the computing device to: receive the network authentication code from the card by way of the radio-frequency receiver; and transmit the network authentication code to a network-interconnected authentication server by way of the network communication interface.

Other features will become apparent from the drawings in conjunction with the following description.

### BRIEF DESCRIPTION OF THE DRAWINGS

In the figures which illustrate example embodiments,

FIG. 1 is a network diagram illustrating a data communication network interconnecting a merchant POS terminal and a remote authentication server, and a payment card presented to the merchant POS terminal to conduct a transaction, exemplary of an embodiment;

FIG. 2A and FIG. 2B are front and rear views, respectively, of the card of FIG. 1;

FIG. 3 is a schematic diagram showing components of the card of FIG. 1;

FIG. 4 is a high-level block diagram of a smart chip of the card of FIG. 1;

FIG. 5 is a flowchart depicting exemplary blocks performed by the card of FIG. 1,

FIG. 6 is a network diagram illustrating a data communication network interconnecting a computing device and a remote authentication server, and a payment card presented to the computing device to conduct a transaction, exemplary of an embodiment; and

FIG. 7 is a high-level block diagram of the computing device of FIG. 6;

FIG. 8 is a flowchart depicting exemplary blocks performed by the computing device of FIG. 6.

### DETAILED DESCRIPTION

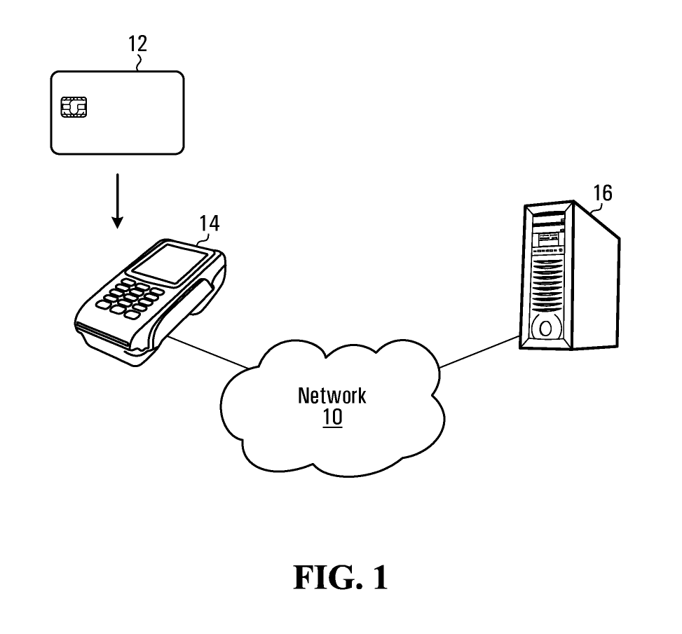

FIG. 1 depicts payment card 12 presented to merchant POS terminal 14 to conduct a transaction (e.g., a credit card or debit card transaction), exemplary of an embodiment. As will become apparent, presenting card 12 to merchant POS terminal 14 causes card 12 to perform authentication operations to verify the authenticity of card 12, and the transaction is allowed to proceed only if card 12 verified to be authentic.

An example merchant POS terminal 14 is illustrated. Terminal 14 may be a conventional device, as produced by, e.g., VeriFone, Hypercom, or Ingenico, and is operated in manners detailed below. Terminal 14 is typically located at a merchant's premises and is used to conduct payment card transactions (e.g., credit card or debit card transactions) between a merchant and a card bearer. As detailed below, when a transaction is conducted, terminal 14 obtains card information from a card (e.g., card 12) and transmits this information to remote authentication server 16. To this end, terminal 14 is configured to communicate with card 12, as well as remote authentication server 16.

In the depicted embodiment, terminal 14 includes an LCD display for displaying information to a user, a keypad for receiving user input, a slot through which the magnetic stripe of a card (e.g., card 12) can be swiped to allow terminal 14 to read from that stripe, a slot for receiving a card with a smart chip to allow terminal 14 to communicate with that smart chip by way of the chip's contact pins, a radio-frequency (RF) interface to allow terminal 14 to communicate with the smart chip by way of RF signals, and a network interface to allow terminal 14 to communicate with a remote authentication server by way a data network (e.g., data network 10).

An example authentication server 16 is illustrated. Server 16 may be a conventional server-class computing device adapted to service requests to process payment card transactions (e.g., credit card or debit card transactions). Server 16 is typically operated by the issuing bank of a credit card or a delegate of the issuing bank.

The architecture of server 16 is not specifically illustrated. Server 16 may include one or more processors, memory, and a network interface to allow server 16 to communicate with network-interconnected merchant POS terminals (e.g., terminal 14). Server 16 may store and execute a network-aware server operating system (e.g., Unix, Linux, Windows Server, or the like). Server 16 may be in communication with one or more databases storing credit card data and card bearer data.

As illustrated, terminal 14 and server 16 are interconnected by data network 10. Data network 10 may include any combination of wired and wireless links capable of carrying packet-switched traffic. For example, these links may include links of a cellular data network (e.g., a GPRS or LTE network) and/or the public Internet.

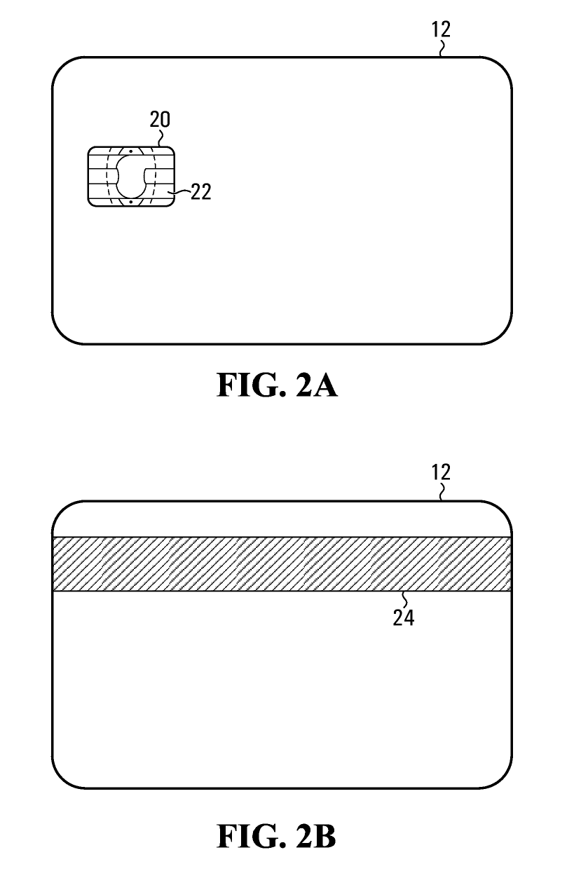

FIG. 2A and FIG. 2B depict the front and rear views, respectively, of card 12. As depicted, the exterior of card 12 is similar to a conventional smart card. In particular, card 12 has plastic front and rear surfaces, with contact pins 22 of smart chip 20 exposed on its front surface and magnetic stripe 24 affixed to its rear surface. In some embodiments, the front surface of card 12 may also include additional features such as, e.g., the card bearer's name, the card's account number, and the card's expiry date, etc., printed or embossed thereon. Similarly, in some embodiments, the rear surface of card 12 may also include additional features such as, e.g., a security code or a signature panel.

In the depicted embodiment, card 12 is dimensioned to be readily carried by a user (e.g., in a wallet). For example, card 12 may have dimensions that accord with published international standards such as ISO/IEC 7810. In embodiments that conform to the ID-1 format defined by the ISO/IEC 7810 standard, card 12 has a width of approximately 85.60 mm, a height of approximately 53.98 mm, and a thickness of approximately 0.76 mm. The dimensions of card 12 (e.g., thickness, width, height) may vary in other embodiments. Card 12 may be formed to have other physical characteristics (e.g., flammability, toxicity, stiffness, durability, etc.) that accord with the ISO/IEC 7810 standard.

Magnetic stripe 24 may be a conventional magnetic stripe for storing data. As such, magnetic stripe 24 stores data using a plurality of bits positions, where each bit position can each be set to a value of 0 or 1 by altering the state of magnetic domains at that bit position. In some embodiments, magnetic stripe 24 may store data in a format that accords with published international standards such as ISO/IEC 7811. As such, magnetic stripe 24 may be organized to store data in three separate data tracks, namely, track 1, track 2, and track 3.

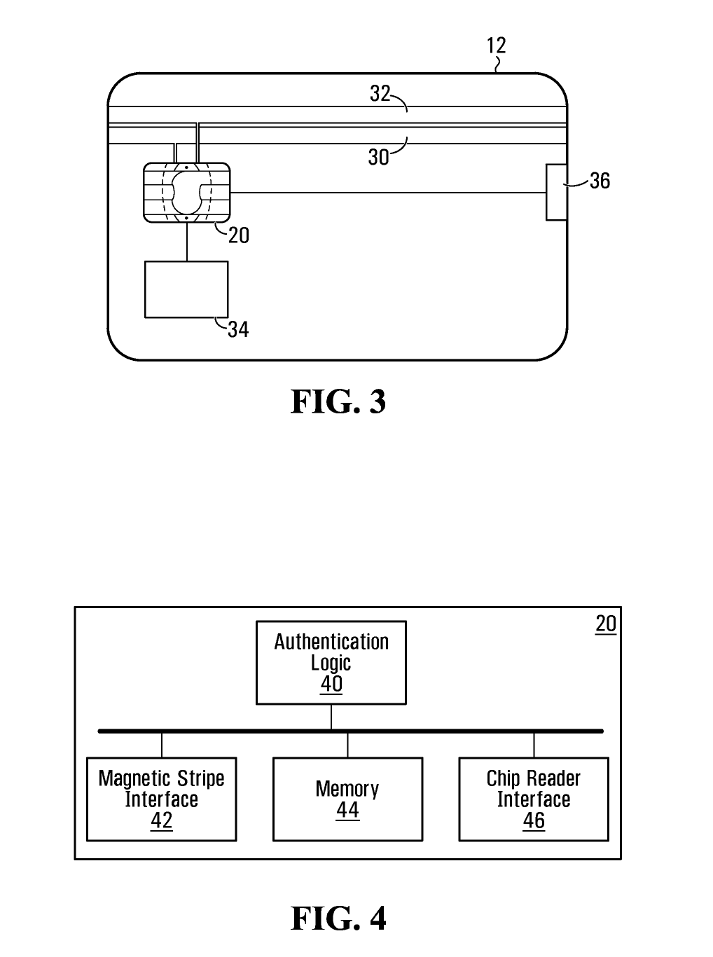

FIG. 3 schematically illustrates the internal components of card 12, exemplary of an embodiment. As shown, card 12 includes smart chip 20. Smart chip 20 may be a conventional smart chip as produced by, for example, Siemens, Infineon, STMicroelectronics, NXP Semiconductors, etc. In an embodiment, smart chip 20 may be the Siemens SLE4442 chip. Smart chip 20 includes logic adapting card 20 to perform authentication operations in manners of embodiments, as detailed below.

Card 12 also includes write circuit 30 that allows smart chip 20 to write data to at least part of magnetic stripe 24, read circuit 32 that allows smart chip 20 to read from at least part of magnetic stripe 24, embedded power supply 34 that supplies power to card 12, and swipe detector 36 that detects when card 12 has been swiped through a merchant POS terminal.

Write circuit 30 includes at least one write head that operates under control of smart chip 20 to set the magnetic state of particular bit positions of magnetic stripe 24. Each write head may include a magnetic transducer that converts a signal from smart chip 20 to magnetic energy to set the state of magnetic domains at one or more bit positions of magnetic stripe 24, thereby storing a value of 0 or 1 at each of those bit positions. In an embodiment, multiple write heads may be arranged in an array along the magnetic stripe 24 to write to respective bit positions along the stripe. In some embodiments, write circuit 30 may include write heads as described in U.S. Pat. No. 7,044,394 to Brown. In other embodiments, write circuit 30 may include write heads formed as an array or a multi-dimensional matrix of conductors, as described in, e.g., International Patent Publication WO 2004/095169 to Osterweil or U.S. Pat. No. 7,591,427 to Osterweil. The array/matrix of conductors may be embedded in card 12 proximate magnetic stripe 24.

Data written to magnetic stripe 24 may be read by smart chip 20 by way of read circuit 32, as detailed below, or by a merchant POS terminal (e.g., terminal 14) upon swiping card 12 through the terminal.

Read circuit 32 includes at least one read head that operates under control of smart chip 20 to read the magnetic state of particular bit positions of magnetic stripe 24. Each read head may include a sensor that senses the state of magnetic domains at one or more bit positions of magnetic stripe 24 and generates a signal representative of that state (e.g., indicating a value of 0 or 1 for a particular bit position). In an embodiment, multiple read heads may be arranged in an array along the magnetic stripe 24 to read from respective bit positions along the stripe. In some embodiments, read circuit 32 may include reads heads that sense the magnetic state of particular bit positions using fluxgate sensors, as described in U.S. Pat. No. 7,591,427 to Osterweil.

In some embodiments, a single circuit may be used for both reading and writing. For example, this circuit could include write-heads adapted to also read from a magnetic stripe, or read-heads adapted to also write to a magnetic stripe.

Given the relative thinness of card 12 in some embodiments, one or both of write circuit 30 and read circuit 32 may be formed using nanotechnologies, e.g., using conductive carbon nanowires. Similarly, write circuit 30 and read circuit 32 may be interconnected with smart chip 20 by way of conductive carbon nanowires. Conveniently, as will be appreciated, carbon nanowires may be smaller and/or lighter than conventional conductors. Further, carbon nanowires may exhibit improved durability, improved thermal stability, and higher magnetic coercivity, compared to conventional conductors.

Embedded power supply 34 supplies power to operate card 20 when card 20 is unable to draw power an external source, e.g., from merchant POS terminal by way of contact pins 22. For example, power supply 34 may supply power to operate card 20 when swiped through a magnetic-stripe merchant POS terminal. In an embodiment, power supply 34 may include a thin, flexible lithium polymer battery, as manufactured by, for example, Solicore of Lakeland, Fla.

Swipe detector 36 detects when card 12 has been swiped through a merchant POS terminal (e.g., terminal 14). In some embodiments, swipe detector 36 includes a pressure sensor to detect pressure applied to card 12 when it is swiped through a merchant POS terminal. In other embodiments, swipe detector 36 includes a sensor that detects the electromagnetic signature of a merchant POS terminal, e.g., of the terminal's magnetic stripe read heads. In some embodiments, swipe detector 36 includes read-head detectors as described in U.S. Patent Publication 2012/0318871 to Mullen et al.

FIG. 4 is a high-level block diagram of smart chip 20, exemplary of an embodiment. When card 12 is used to conduct a transaction, card 12, under control of smart chip 20, performs authentication operations in manners of embodiments, as detailed below. As depicted, the smart chip 20 is an integrated circuit that includes authentication logic 40, magnetic stripe interface 42, memory 44, and card reader interface 46.

Authentication logic 40 includes logic to control authentication operations performed by card 12. Two authentication operations are performed, namely, authentication of card 12 performed by card 12 itself, hereinafter referred to as “self-authentication”, and authentication of card 12 performed by card 12 in cooperation with a remote authentication server (e.g., server 16), hereinafter referred to as “network authentication.” Authentication logic 40 may be implemented using a combination of hardware and software components of smart chip 20, including, e.g., software code stored in EEPROM of smart chip 20.

Memory 44 is interconnected to authentication logic 40 and stores data used during the aforementioned self-authentication and network authentication operations. Of note, memory 44 includes a protected memory region that is protected by smart chip 20 against read access and write access after data is written to it. In particular, data written to this protected memory region can only be accessed by comparing input data to the written data, which will yield a binary result indicating whether or not the input data matches the written data. In embodiments in which smart chip 20 is a Siemens SLE4442 chip, the Manufacturer Code partition of this Siemens chip functions as the above-described protected memory region. As will become apparent, this protected memory region of memory 44 stores an authentication code used by smart chip 20 to perform self-authentication.

Magnetic stripe interface 42 is interconnected to authentication logic 40 and allows smart chip 20, under control of authentication logic 40, to communicate with write circuit 30 and read circuit 32. Card reader interface 46 is also interconnected to authentication logic 40 and allows smart chip 20, under control of authentication logic 40, to communicate with a card reader. For example, card reader interface 46 may allow smart chip 20 to communicate with a merchant POS terminal, e.g., by way of contact pins 22 or by way of RF communication. In other embodiments, card reader interface 46 may allow communication with other types of devices, such as a computing device as described below or any other device adapted to communicate with a card's smart chip. Such devices may be referred to collectively as card readers. To facilitate RF communication, card reader interface 46 may include an RF transmitter and/or RF receiver, interconnected with an RF antenna embedded in card 12 (not shown). In some embodiments RF communication may be conducted using the near field communication (NFC) protocol.

As noted, card 12, under control of smart chip 20, performs self-authentication by itself, and network authentication in cooperation with a remote authentication server (e.g., server 16). Two separate secret authentication codes are used for these authentication operations, namely, a card authentication code to perform self-authentication and a network authentication code to perform network authentication.

Self-authentication is performed by card 12 by comparing a first copy of the card authentication code stored at a first location on card 12 with a second copy of the card authentication code stored at a second location on card 12, and card 12 is verified to be authentic only if these two copies of the card authentication code match. In the depicted embodiment, the first copy of the card authentication code is stored in smart chip 20, specifically, in the protected memory region of memory 44 discussed above, while a second copy of the card authentication code is stored on magnetic stripe 24. When performing self-authentication, the second copy of the card authentication code may be read from magnetic stripe 24 by smart chip 20 using read circuit 32. The card authentication code may be assigned to card 12 at time of manufacture, and may be unique to card 12.

In some embodiments, the second copy of the card authentication code may be stored on magnetic stripe 24 in encrypted form. Conventional encryption techniques may be used for this purpose. For example, symmetric-key encryption technique such as, e.g., AES, DES, 3DES, or the like may be used. Alternatively, asymmetric-key encryption such as RSA may also be used. Other encryption techniques apparent to a person skilled in the art may also be used instead of or in conjunction with the techniques listed above. In some embodiments, customized or proprietary encryption techniques may also be used. The encryption key may be unique to card 12.

Conveniently, storing the first copy of the card authentication code in the protected memory region of memory 44 and the second copy of the card authentication code on magnetic stripe 24 in encrypted form prevents the card authentication code from being read by a would-be fraudster, e.g., using a compromised merchant POS terminal. This prevents duplication of the card authentication code of card 12 in any counterfeit copy of card 12.

Furthermore, as the copies of card authentication code are stored at two separate locations on card 12, any counterfeit copy of card 12 that replicates the data of only one of these locations would not be able to successfully perform self-authentication. For example, a counterfeit copy of card 12 that only replicates the contents of magnetic stripe 24 would not be able to successfully perform self-authentication.

Network authentication is performed by card 12 in cooperation with remote authentication server 16 by comparing a first copy of the network authentication code stored at card 12 with a second copy of the network authentication code stored at server 16. In the depicted embodiment, the first copy of the network authentication code is stored on magnetic stripe 24. When performing network authentication, the copy of the network authentication code stored on magnetic stripe 24 is read by smart chip 20 using read circuit 32, and is then passed by smart chip 20 to server 16, where it is compared against the copy of the network authentication stored there. Further, as detailed below, this copy of the network authentication code stored on magnetic stripe 24 may be updated by smart chip 20 using write circuit 30.

In some embodiments, smart chip 20 maintains another copy of the network authentication code at a location on card 12 separate from magnetic stripe, e.g., in memory 44.

Conveniently, storing a copy of the network authentication code on magnetic stripe 24 provides for compatibility with merchant POS terminals that are unable to communicate with smart chip 20 but are able to read from magnetic stripe 24. In particular, the network authentication code may be read by the merchant POS terminal when card 12 is swiped through the terminal, and the code may then be passed to server 16 to perform network authentication.

In the depicted embodiment, all copies of the card authentication code and the network authentication code are stored on card 12 in locations or forms that prevent those codes from being read by a would-be fraudster at the point of sale, e.g., using a compromised merchant POS terminal. As noted, the first copy of the card authentication code is stored in the protected memory region of memory 44. Meanwhile, the second copy of the card authentication code and the first copy of the network authentication code are stored on magnetic stripe 24 in encrypted form. Conveniently, this prevents duplication of these codes in any counterfeit copy of card 12.

In other embodiments, copies of the card authentication code and/or the network authentication code may be stored in other suitable locations, as will be apparent to those of ordinary skill in the art, e.g., in other memory locations within smart chip 20, or in other memory locations accessible by smart chip 20.

In contrast to a conventional payment card that stores card information (e.g., a credit/debit card account number, expiry date, etc.) on track 1 and track 2 of its magnetic stripe while leaving track 3 unused, in the depicted embodiment, the card authentication code and the network authentication code on magnetic stripe 24 are stored on track 3. In some embodiments, track 1 and track 2 of magnetic stripe 24 may continue to store card information in a conventional way. In other embodiments, track 1 and track 2 of magnetic stripe 24 may simply be left unused (blank), and card information may be stored on track 3 of magnetic stripe 24 instead. Any card information stored on track 3 of magnetic stripe 24 may be in encrypted form. Conveniently, conventional merchant POS terminals may be adapted to read from track 3 by updating its software/firmware, while avoiding any hardware changes.

As noted, the network authentication code stored on magnetic stripe 24 may be updated by smart chip 20 using write circuit 30. This allows the network authentication code to be changed from time to time. Conveniently, changing the network authentication code from time to time ensures that, in the event that the network authentication code is copied to a counterfeit card, the network authentication code may only be used to perform network authentication for a limited time, e.g., until the next time the network authentication code changes.

As will be appreciated, to facilitate network authentication, the respective copies of the network authentication code stored at card 12 and at server 16 are changed in such a way that the two copies of the network authentication codes remain matching after each change. For example, the network authentication codes may be changed at card 12 and at server 16 according to a predetermined sequence, or according to a predetermined code-generation algorithm.

Further, the respective copies of the network authentication code stored at card 12 and server 16 are updated synchronously. For example, in some embodiments, these copies of the network authentication code could be updated at a predetermined time interval (e.g., every 30 minutes). In such embodiments, the network authentication code could include, or be generated using, a current timestamp (e.g., indicating time and date). The network authentication code could also be generated according to a pseudo-random sequence. A copied card having a stale timestamp or pseudo-random sequence value may be readily identified as being a counterfeit card.

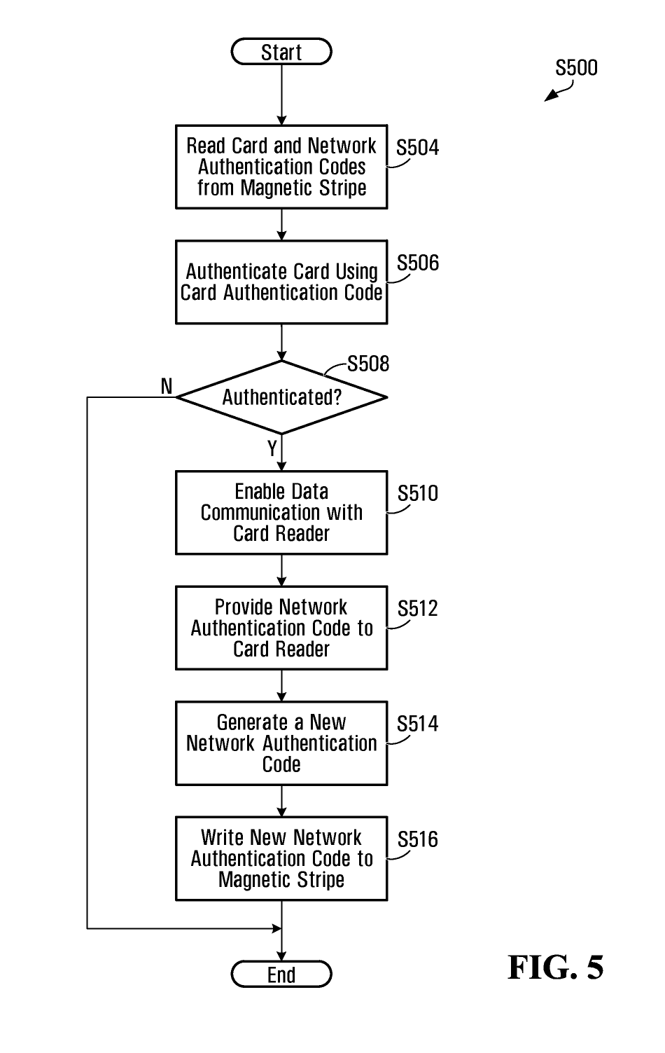

In some embodiments, including the depicted embodiment further described with reference to FIG. 5 below, the copies of the network authentication could be updated following each transaction. In such embodiments, the network authentication code may include, or be generated using a transaction identifier that uniquely identifies each transaction. Of course, this network authentication code may also include, or be generated using a timestamp as well.

Optionally, when network authentication is performed, the copy of network authentication code at card 12 may be allowed to deviate by a predefined margin from the copy of the network authentication code at server 16. For example, if the network authentication code includes a timestamp, then the respective timestamps of the two copies of the network authentication code may be allowed to deviate by a predefined time interval (e.g., 30 seconds, one minute, etc.). Similarly, if the network authentication code includes a transaction identifier, then the respective transaction identifiers of the two copies of the network authentication code may be allowed to deviate by a predefined number of transactions. In this way, network authentication may be allowed to complete successfully even if the copies of the network authentication code being compared do not match exactly.

Smart chip 20 updates the copy of the network authentication on magnetic stripe 24 in response to receiving a signal indicative of a new transaction. When card 12 is used to conduct a transaction in conjunction with a merchant POS terminal that communicates with smart chip 20, smart chip 20 receives a signal indicative of a new transaction directly from the terminal. When card 12 is used to conduct a transaction in conjunction with a merchant POS terminal that reads from magnetic stripe 24 without communicating with smart chip 20, smart chip 20 relies on a signal from swipe detector 36 indicating that card 12 has been swiped through a merchant POS terminal.

When smart chip 20 updates the copy of the network authentication on magnetic stripe 24 while connected to a merchant POS terminal by way of contacts 22, smart chip 20 may draw power from the terminal. When smart chip 20 performs updates at other times, it may draws power from embedded power supply 34.

FIG. 5 depicts the authentication operations performed by smart chip 20 when card 12 is used to conduct a transaction at a merchant POS terminal 14. Prior to performing block S500, card 12 is initialized for use. In particular, a copy of the card authentication code is written to protected memory region of memory 44 in smart chip 20, and a matching copy of the card authentication code is written to magnetic stripe 24. A copy of the network authentication code is also written to magnetic stripe 24; this copy of the network authentication code matching the copy of the network authentication code stored at server 16.

Smart chip 20, under control of authentication logic 40, begins performing blocks S500 and onward when terminal 14 initiates communication with smart chip 20 to conduct a new transaction. In response, at block S504, smart chip 20 reads the copy of the card authentication code and the copy of the network authentication code stored on magnetic stripe 24 by way of read circuit 32. At the same time, smart chip 20 may also read card information (e.g., credit/debit card account number, expiry date, etc.) stored on magnetic stripe 24 by way of read circuit 32. If the copy of the card authentication code read from magnetic stripe 24 is encrypted, smart chip 20 decrypts it so that it may be used to perform self-authentication.

At block S506, smart chip 20 performs self-authentication by comparing the copy of the card authentication code read from magnetic stripe 24 against the expected card authentication code, as reflected in the copy of the card authentication code written to memory 44. As noted, upon performing this comparison, smart chip 20 obtains a binary result indicating whether or not the two copies of the card authentication code match.

If this result indicates that the two copies of the card authentication code match, then card 12 is verified to be authentic at block S508, and processing of the transaction is allowed to continue. Otherwise, self-authentication fails and the transaction is terminated.

Of note, data communication from smart chip 20 to the smart chip interface of terminal 14 is disabled until self-authentication has been successfully performed, e.g., by disabling the RF transmitter of smart chip 20 or disabling one or more pins of contact pins 22 until self-authentication has been successfully performed. Accordingly, at block S510, after self-authentication has been successfully performed, data communication from smart chip 20 to the smart chip interface of terminal 14 is enabled.

Next, at block S512, network authentication is initiated by smart chip 20 by transmitting the copy of the network authentication code read from magnetic stripe 24 to terminal 14. Terminal 14 then relays this copy of the network authentication code to server 16, where it is compared against the expected network authentication code, as reflected in the copy of the network authentication code stored at server 16. Server 16 determines card 12 to be authentic if the two copies of the network authentication code match.

Optionally, at block S512, smart chip 20 may compare the copy of the network authentication code read from magnetic stripe 24 to another copy of the network authentication code stored in memory of card 12 separate from magnetic stripe 24. If these two copies of the network authentication code do not match, then smart chip 20 may terminate the transaction.

Along with the network authentication code, smart chip 20 may also transmit any card information (e.g., credit/debit card account number) required to conduct the payment card transaction to terminal 14. This card information is also relayed by terminal 14 to server 16 for processing the transaction.

If the copy of the network authentication code and/or card information read from magnetic stripe 24 is encrypted, they may be transmitted to terminal 14 in encrypted form for relay to server 16. In this way, this data is protected from being copied at terminal 14 or during subsequent transmission to server 16. Smart chip 20 may additionally send a unique card identifier to server 16 in unencrypted form to allow server 16 to select the appropriate decryption key.

Following self-authentication, smart chip 20 may also perform a user authentication operation. For example, smart chip 20 may prompt the user to enter a numeric code (i.e., secret PIN) by way of the keypad of terminal 14, which is then verified by smart chip 20.

Upon completion of a transaction, smart chip 20 updates the network authentication code stored at magnetic stripe 24. In particular, at block S514, smart chip 20 generates a new network authentication code, and at block S516, smart chip 20 writes a copy of the new network authentication code to magnetic stripe 24 using write circuit 30. Smart chip 20 may encrypt the copy of the network authentication code written to magnetic stripe 24. At this time, the same new network authentication code is also generated and stored at server 16, to be used to perform network authentication for the next transaction.

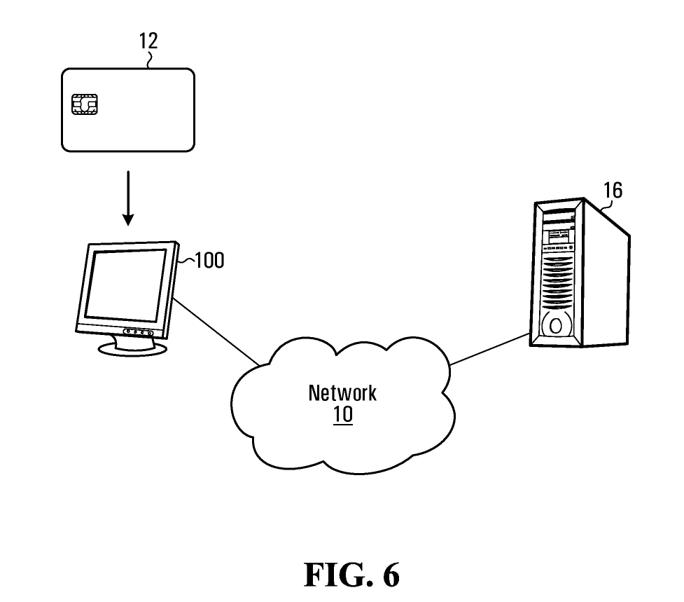

FIG. 6 depicts payment card 12 presented to a computing device 100 to conduct an e-commerce transaction with a merchant, exemplary of an embodiment. In this embodiment, the above-discussed self-authentication and network authentication operations are performed in the absence of a merchant POS terminal, e.g., when card 12 is used in the card bearer's home.

An exemplary computing device 100 is shown. Computing device 100 may be a device such as a desktop personal computer, a laptop computing device, a network computing device, a tablet computer, a personal digital assistant, a mobile phone, a smart television device, a video gaming console device, or the like, adapted to operate in the manner discussed below.

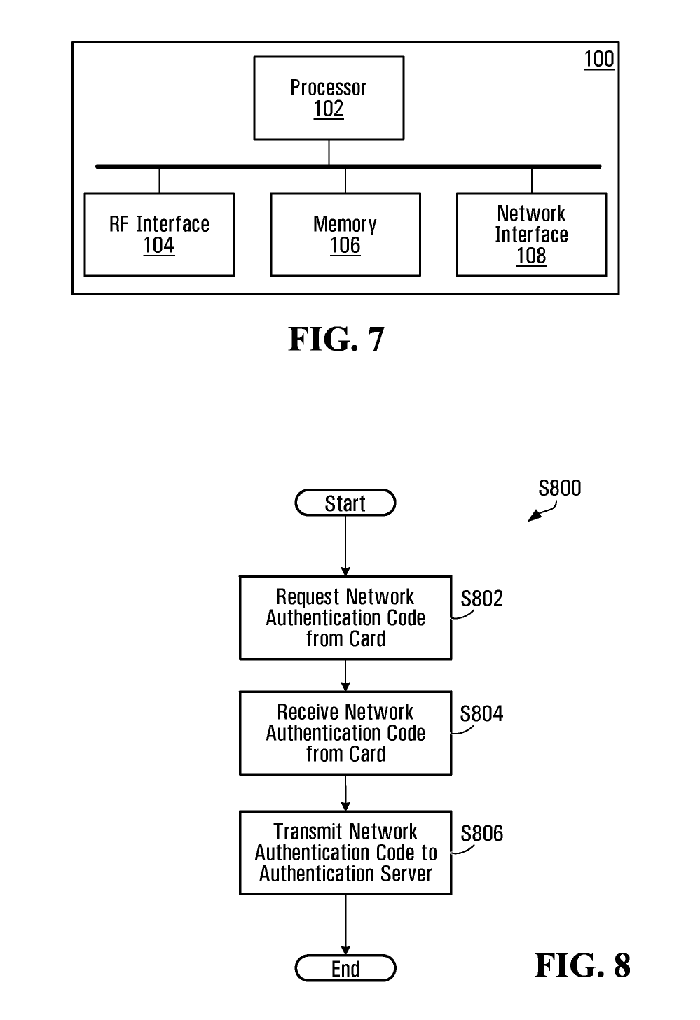

As shown in the high-level block diagram of FIG. 7, computing device 100 includes at least one processor 102 and memory 106 in communication with processor 102. Memory 106 stores software code, that when executed by processor 102, causes computing device 100 to conduct a payment card transaction (e.g., a credit/debit card transaction) in cooperation with card 12 and server 16.

As depicted, computing device 100 also includes RF interface 104 that allows device 100 to communicate with card 12 by way of RF communication. In some embodiments, RF interface 104 includes a peripheral communication port (e.g., Universal Serial Bus, IEEE 1394, Serial, or the like) that allows a RF transmitter and/or a RF receiver to be removably attached to computing device 100. In other embodiments, computing device 100 may include an integral RF transmitter/receiver, e.g., where computing device 100 is a mobile phone or a tablet computer. In some embodiments, computing device 100 may use RF interface 104 to communicate with card 12 using the NFC protocol.

As depicted, computing device 100 also includes a network interface that allows device 100 to communicate with network-connected devices (e.g., server 16) by way of data network 10. Computing devices 100 typically store and execute network-aware operating systems including protocol stacks, such as a TCP/IP stack. Computing device 100 may also store and execute web browsers such as Microsoft Internet Explorer, Mozilla Firefox, Google Chrome, Apple Safari, or the like, to allow the bearer of card 12 to conduct web-based payment card transactions.

The operation of computing device 100 is further described with reference to FIG. 8, which depicts exemplary blocks performed by computing device 100 to conduct a payment card transaction. A transaction is initiated by a user (e.g., the bearer of card 12) operating computing device 100, for example, with a remote merchant by way of a web site operated by that merchant. Computing device 100 then performs blocks S800 and onward.

At block S802, computing device 100 transmits a signal by way of RF interface 104 to card 12 indicating that a transaction has been initiated and requesting that card 12 provide its network authentication code. Upon receiving this signal, card 12 performs the authentication operations depicted in FIG. 5, as discussed above, including the self-authentication operation discussed above.

Card 12 may refuse to provide the requested network authentication code if self-authentication fails, in which case the transaction is terminated. However, if self-authentication is performed successfully at card 12, at block S804, computing device 100 receives a network authentication code from card 12 by way of RF interface 104. At block S806, computing device 100 transmits the received network authentication code to server 16 by way of network interface 108.

Computing device 100 may also transmit any additional card information (e.g., a credit/debit card account number) received from card 12 to server 16. When data is received from card 12 in encrypted form, computing device 100 may relay it to server 16 without decrypting that data.

Server 16 performs network authentication using the network authentication code relayed by computing device 100, in manners described herein. Upon performing network authentication, server 16 may authorize or reject the transaction.

In the exemplary embodiments detailed above, card 12 is a payment card. However, in other embodiments, card 12 may be another type of card such as, for example, an identity card, a security access card, a membership card, a driver's license, a health care card, military personnel card, etc. Other types of cards will be apparent to those of ordinary skill in the art. The authentication operations described herein, including self-authentication and network authentication, may also be used in these other types of cards.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A self-authenticating card comprising:
a magnetic stripe storing a card authentication code and a network authentication code;
at least one sensor for reading from said magnetic stripe;
at least one write-head for writing to said magnetic stripe;
a communication interface for communicating with a card reader; and
an authentication circuit interconnected to said at least one sensor, said at least one write head, and said communication interface;
said authentication circuit operable to:
read said card authentication code and said network authentication code from said magnetic stripe using said at least one sensor;
authenticate said card using said card authentication code by comparing said card authentication code with an expected code stored in memory separate from said magnetic stripe;
in response to authenticating said card using said card authentication code:
enable data communication with said card reader by way of said communication interface;
provide said network authentication code to said card reader by way of said communication interface;
generate a new network authentication code; and
write said new network authentication code to said magnetic stripe using said at least one write-head.

2. The card of claim 1, wherein said communication interface comprises a radio-frequency transmitter.

3. The card of claim 1, further comprising a power source that supplies power to said authentication circuit.

4. The card of claim 1, further comprising a swipe detector operable to detect a swipe of said card in a card reader.

5. The card of claim 4, wherein said authentication circuit is operable to update said network authentication code stored in said magnetic stripe, in response to detecting a swipe of said card in a card reader.

6. The card of claim 1, wherein said authentication circuit is operable to update said network authentication code stored in said magnetic stripe at pre-defined time intervals.

7. The card of claim 1, wherein said network authentication code is stored on said magnetic stripe in encrypted form, and said authentication circuit is operable to decrypt and encrypt said network authentication code.

8. The card of claim 1, wherein said network authentication code comprises at least one of a timestamp and a transaction identifier.

9. The card of claim 1, wherein said authentication circuit is operable to authenticate said card using said network authentication code by comparing said network authentication code with an expected network code stored in memory separate from said magnetic stripe.

10. The card of claim 1, wherein said authentication circuit is operable to, in response to generating a new network authentication code, update said expected network code to reflect said new network authentication code.

11. The card of claim 1, wherein said card authentication code is stored on said magnetic stripe in encrypted form, and said authentication circuit is operable to decrypt said card authentication code.

12. The card of claim 1, wherein said card authentication code comprises a unique card identifier.

13. The card of claim 1, wherein said memory separate from said magnetic stripe is adapted to prevent read access by a card reader.

14. The card of claim 1, wherein said memory separate from said magnetic stripe is integral to said authentication circuit.

15. The card of claim 1, wherein said at least one write-head comprises carbon nanowires.

16. The card of claim 1, wherein said card is at least one of a payment card and an identification card.

17. A method of operating a card to authenticate itself, said card having a magnetic stripe and an authentication circuit in communication with said magnetic stripe, said method comprising:
storing a card authentication code and a network authentication code on said magnetic stripe;
at said authentication circuit:
reading said card authentication code and said network authentication code from said magnetic stripe;
authenticating said card using said card authentication code by comparing said card authentication code with an expected code stored in memory separate from said magnetic stripe;
in response to authenticating said card using said card authentication code:
enabling data communication with a card reader;
providing said network authentication code to said card reader;
generating a new network authentication code; and
writing said new network authentication code to said magnetic stripe.

18. The method of claim 17, further comprising detecting a swipe of said card in a card reader.

19. The method of claim 17, further comprising updating said network authentication code stored in said magnetic stripe, in response to detecting a swipe of said card in a card reader.

20. The method of claim 17, further comprising updating said network authentication code stored in said magnetic stripe at pre-defined intervals.

21. The method of claim 17, wherein said network authentication code is stored on said magnetic stripe in encrypted form, and said method further comprises decrypting and encrypting said network authentication code.

22. The method of claim 17, further comprising, at said authentication circuit, authenticating said card using said network authentication code by comparing said network authentication code with an expected network code stored in memory separate from said magnetic stripe.

23. The method of claim 22, further comprising, in response to generating a new network authentication code, updating said expected network code to reflect said new network authentication code.

24. The method of claim 17, wherein said card authentication code is stored on said magnetic stripe in encrypted form, and said method further comprises decrypting said card authentication code.

25. A card authentication system comprising:
said card of claim 2; and
a computing device comprising:
a radio-frequency receiver;
a network communication interface;
at least one processor; and
memory interconnected to said at least one processor, said memory storing software code that, upon execution by said at least one processor, causes said computing device to:
receive said network authentication code from said card by way of said radio-frequency receiver; and
transmit said network authentication code to a network-interconnected authentication server by way of said network communication interface.

26. The card authentication system of claim 25, wherein said computing device further comprises a peripheral communication port and said radio-frequency receiver is removably attached to said peripheral communication port.

27. The card authentication system of claim 26, wherein said peripheral communication port is a Universal Serial Bus port.

28. The card authentication system of claim 25, wherein said computing device is a mobile phone or a tablet computer.
